(19) United States
(12) Patent Application Publication
(10) Pub. No.: US 2008/0240239 A1
(43) Pub. Date: Oct. 2, 2008

(54) METHODS AND APPARATUS TO SELECTIVELY REDUCE STREAMING BANDWIDTH CONSUMPTION

(76) Inventor: David A. Stuart, Portsmouth, RI (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/061,257

(22) Filed: Apr. 2, 2008

Related U.S. Application Data
(60) Provisional application No. 60/909,578, filed on Apr. 2, 2007.

(51) Int. Cl. H04B 1/66

(52) U.S. Cl. 375/240.12; 375/E07.026

(57) ABSTRACT

Methods and apparatus to selectively transmit compressed data based upon whether a image movement threshold has been met. In one embodiment, edge map frames are transmitted during periods of camera movement. Edge maps generated from a video stream are processed to identify the periods of camera movement.

### CROSS REFERENCE TO RELATED APPLICATIONS

The present application claims the benefit of U.S. Provisional Patent Application No. 60/909,578, filed on Apr. 2, 2007, which is incorporated herein by reference.

### BACKGROUND

As is known in the art, motion picture technology is a technology where the illusion of motion is produced through the rapid projection of still photographs. The duration each photograph is allowed to persist is constant from photograph to photograph, and the interval required to switch from one photograph to another is also constant.

As is also known in the art, television technology works similarly in that a scanning electron beam sweeps a spot from the top left corner of a cathode-ray tube to the bottom right corner of the cathode-ray tube in a manner known in the art as a “raster scan”. The period of time required to make a full scan of the cathode-ray tube is constant, and the interior of the cathode-ray tube is painted with a phosphor that continues to glow once the beam has departed to another position on the tube. Each complete raster scan represents a single video flame. When the beam returns to the top left corner of the cathode-ray tube, the process of painting the next frame begins. By repeating this process quickly, the illusion of motion occurs to the viewer.

Current digital video technology operates in much the same way as motion picture projection and television. Digital information is stored in memory and is used to change the state of a digital or analog display in a manner that conveys a still image on the screen. By repeating this process quickly, the illusion of motion is conveyed to the viewer.

One video property relates to the characteristics of each still image and another property relates to rapidly sequencing through a series of still images in order to convey the illusion of motion. A particular still image can be referred to as a “frame,” while a time-ordered series of frames can be referred to as “video,” “video sequence,” “video stream,” “sequence,” “streaming video,” or simply as a “stream.”

Streaming video refers to the transmission of images, such as from a video camera, over a transmission medium, a length of copper wire, a length of fiber optical cable, or through wireless broadcast using radio frequencies. It is also known in the art that certain video equipment may be readily procured, and the property of any hardware or software that may be readily procured is commonly referred to as COTS (an acronym for “Commercial Off-The-Shelf”). Also, as is known in the art, compression refers to a method of storing information in a compact form resulting in a net reduction of information being transmitted, and decompression is known in the art as a method for restoring the compressed information into its original form, or nearly so. Each compression algorithm has a corresponding decompression algorithm, and the pair (compression algorithm and decompression algorithm) are known in the art as a “CODEC” (an acronym for CODER-DECODER, or COMPRESSION-DECOMPRESSION). It is commonly known in the art that many CODECs are readily available, and they are COTS CODECs.

It is common practice to eliminate certain information from the data being compressed as a technique for reducing the amount of information being transmitted. Once a compression algorithm has eliminated this information, it cannot be restored. The extent to which information is lost during this compression, and subsequent decompression step, is characterized in the art as the ‘lossiness’ of the compression algorithm, or CODEC method. Compression and decompression methods that result in high quantities of lost information are known in the art as “lossy algorithms,” “lossy methods,” or “lossy CODECs,” and compression and decompression methods that result in no lost information are known in the art as “lossless algorithms,” “lossless methods,” or “lossless CODECs.” The ultimate goal of any compression method is to reduce the actual amount of information being transmitted as much as possible, while keeping the amount of lost information as low as possible. Many CODECS, such as the MP3 CODEC used to compress audio signals into smaller digital files, make certain assumptions about what is considered useful, and what is considered useless, to a listener of MP3 music. In the case of MP3, certain high frequencies are lost in the compression in order to reduce the size of the resulting MP3 file. This is viewed as an acceptable loss since few people are able to hear those high frequencies that are present in the original music. Hence, it is common practice to sacrifice one thing (e.g., high frequency sounds in a song) in order to gain some other benefit (e.g., highly reduced MP3 file sizes.)

It is further known in the art that various compression methods function more or less efficiently under certain conditions. MPEG4 is one known CODEC for transmitting video over a network, and is considered an extremely efficient compression and decompression method when large portions of a scene in a video frame remain unchanged from frame to frame. An example is a newscast, where most of the background remains unchanged from frame to frame, and only the face of the news anchor changes, from frame to frame. MPEG4, however, becomes extremely inefficient when everything in the scene is in motion. For instance, when a camera is being panned, tilted, or in motion in any axis, all of the information in one frame, compared to previous frames, has changed, and is thus transmitted. The consequence is that, during periods of panning, tilting, zooming in or out, and other such motion, the amount of information being transmitted increases dramatically. For many applications of video, periods of camera repositioning are necessary, and the information in each frame while the camera is in motion is often not useful to a viewer, but is necessary for the camera operator only in order to track the position of the camera on its way to the intended subject. Once the camera operator has found the intended subject, the camera is aimed at that subject, the camera becomes still in all axes, and MPEG4 compression and decompression methods again become efficient. The information being transmitted during the period of camera repositioning becomes worthless to a viewer of the imagery, or of negligible value, when a camera pans, tilts, zooms in or out, or rotates at relatively high rates. In addition, disproportionate amounts of bandwidth are consumed during camera-movement operations while relatively useless data is transmitted.

### SUMMARY

In general, the present invention provides methods and apparatus to selectively compress data for transmission based upon the amount of change in the data over some time interval. The original data can be provided form a wide range of devices and in a wide range of formats. The data in the exemplary embodiment is video imagery. However it's possible that original data can include visual imagery recognizable to a human, or any kind of information that can be expressed in terms of a sequence of frames, such as charts, graphs, radar sweeps, or any other bounded binary string of any finite length. The transmitted data can be provided in various forms, such as compressed, or uncompressed, modified, or unmodified grey scale, color plane, edge map, under sampled, or other technique as a function of the user selectable thresholds that establish whether the data in it's original format should be transmitted, or whether the operations embodied by this invention should be applied before and after transmitted.

In one aspect of the invention, the invention provides methods and apparatus for a CODEC that can (1) maintain a lossy rendition of each and every video frame throughout the course of a video session, (2) detect various thresholds, including those that suggest a camera is in motion, (3) switch to a lossy compression and decompression mode that dramatically reduces the amount of information being transmitted during periods of camera movement, and/or (4) restore the native CODEC video mode upon detecting that the camera is no longer in motion. The extent to which information is lost during periods of camera movement is controllable by the camera operator, a remote operator, and/or software parameters that test various conditions and select the lossiness of the compression.

Exemplary embodiments of the invention include an illustrative data structure referred to as a bit histogram used in processing to gather and store a history of edge maps and time-weighted statistics that describe the map, for high speed processing to preserve video frame rates. The data structure information, in video applications for example, is combined with control data that includes camera telemetry, such as angle of view, pan angle, tilt angle, and other data, and also includes control information that describes the specific compression scheme of the transmitted data. The data structure information can be used to determine whether an ‘edge map’ generated by an edge detection algorithm should be transmitted or whether the full video frame should be transmitted, or some combination thereof, or other lossy rendition of the original video frame.

In one embodiment, the bit-mapped histogram is used to collect statistics as to the character of a frame in terms of the edges being produced by the image. When the camera moves, dramatic statistical anomalies occur relative to the data collected in the bit-mapped histogram. When the camera stabilizes, the time-weighted statistical analysis tends to restore average video characteristics. The system relies upon this real-time statistical analysis in order to decide whether to transmit actual image data, usually a video frame (e.g., RGB24 color, MPEG4 compressed, or other “normal” mode), or a frame containing image outlines, or edges, of the objects in the frame. In the case when dramatic statistical anomalies occur, e.g., during camera movement, the amount of bandwidth required to continue the transmission drops significantly, e.g., up to 96%.

### BRIEF DESCRIPTION OF THE DRAWINGS

The foregoing features of this invention, as well as the invention itself, may be more fully understood from the following description of the drawings in which:

FIG. 1 is a block diagram of a system having streaming in accordance with exemplary embodiments of the invention.

FIG. 2 is a flow diagram showing camera movement detection processing and frame processing;

FIG. 3 is an exemplary RGB24 frame in a video sequence;

FIG. 4 is a red plane for the frame of FIG. 3;

FIG. 5 is a green plane for the frame of FIG. 3;

FIG. 6 is a blue plane for the frame of FIG. 3;

FIG. 7 is a grey scale frame converted from the frame of FIG. 3;

FIG. 8 is a edge map generated from the grey scale frame of FIG. 7;

FIG. 9 is a pictorial representation of a magnified edge map sample from FIG. 8;

FIG. 10 is a matrix of values for a byte frame shown in FIG. 9;

FIG. 11 is a bit mapped edge map;

FIG. 12 is a series of bit-mapped edge maps;

FIG. 13 is a pictorial representation of a pixel vector;

FIG. 14 is a pictorial representation of an exemplary pixel vector contents;

FIG. 15 is a pictorial representation of an exemplary pixel vector containing two sprees;

FIG. 16 is a pictorial representation of an exemplary pixel histogram;

FIG. 17 is a pictorial representation of an exemplary pixel position for a pixel position; and

FIG. 18 is a tabular representation of certain exemplary implementation parameters.

### DETAILED DESCRIPTION

In general, exemplary embodiments of the invention provide methods and apparatus to enable transmission of compressed, lossy frames of video information during periods of camera movement for substantially reducing the amount of transmitted information. While exemplary embodiments primarily show and describe color video streaming and selective compression, it is understood that the term video should be construed broadly to include data in general from which images can be ascertained. The data can be derived from a wide variety of devices, such as cameras, transducers, and sensors in general, that can include electro-optic, infra-red, radio frequency, and other sensor types. In addition, it is understood that image is not limited to visual image, but rather, detection of physical phenomena in general. For example, radar can be used to detect weather patterns, such as rainfall boundaries.

In addition, in exemplary embodiments compressed data is transmitted at certain times. In general, data transmission efficiency can be selectively provided to meet the needs of a particular application.

Further, it is understood that the term network can include any collection of nodes that are connected to enable interaction. The transmission medium can be provided by copper, fiber optic and other light-based carriers, air interface, and the like.

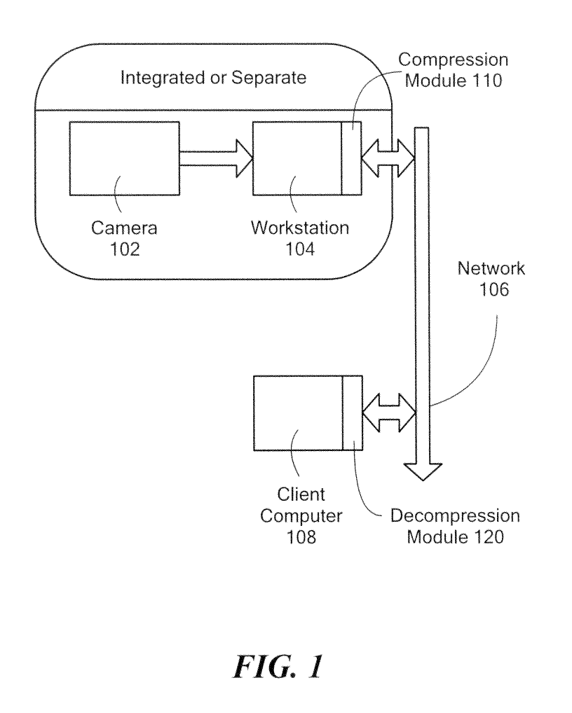

FIG. 1 shows a system 100 having the capability to reduce streaming video bandwidth during times of camera movement in accordance with exemplary embodiments of the invention. A camera 102, or other imaging apparatus, having a field of view (FOV) transmits data (e.g., video) to a workstation 104, or embedded equivalent, coupled to a wired or wireless network 106, such as the Internet or other carrier medium. A client computer 108, or other suitably configured workstation, can display the digital video information from the camera 102.

The imaging apparatus 102 and/or the workstation 104 can include a compression module 110 to selectively transmit complete or degraded video information, as described in detail below, during times of camera movement. Alternatively, the compression module 110 can selectively transmit edge, color, or other data, during times of network distress, network capacity constraint, or other simply as a matter of a users choice.

A decompression module 120 receives the transmitted data and decompresses, or decodes, the compressed video information and provides the decompressed information to the native software resident on the client computer 108. It is understood that movement of the camera includes any positional and/or perspective changes including physical movement, panning, tilting, zooming in or out, and rotation. Movement also includes movement of objects in the camera field of view.

In an exemplary embodiment, the camera 102 or imaging apparatus produces data compliant with RGB24, or convertible to RGB24. It is understood that the data can be made available in the form of a pointer to a data buffer, a stream of demarcated data over a hardware interface, a stream of demarcated data over a software interface, or the like. In one embodiment, it is assumed that there is a pointer to a data buffer containing RGB24 data for each incoming video frame available to this invention for processing.

In general, statistical information is collected for the data stream and analyzed to determine when compressed data should be transmitted to reduce bandwidth consumption. That is, certain statistical information is collected on a frame-by-frame basis, and that data is compared to the statistical data collected over a series of frames to identify periods of camera movement during which an excessive amount of bandwidth could result. In any embodiment, the choice of conditions under which various video CODECS should be employed, including the video CODEC described by this invention, can be made user selectable.

In one embodiment, the threshold of change in the frames that is exceeded before transmission of compressed data can be selected by the user. Further, the data transmitted, compressed or non-compressed, can be determined arbitrarily.

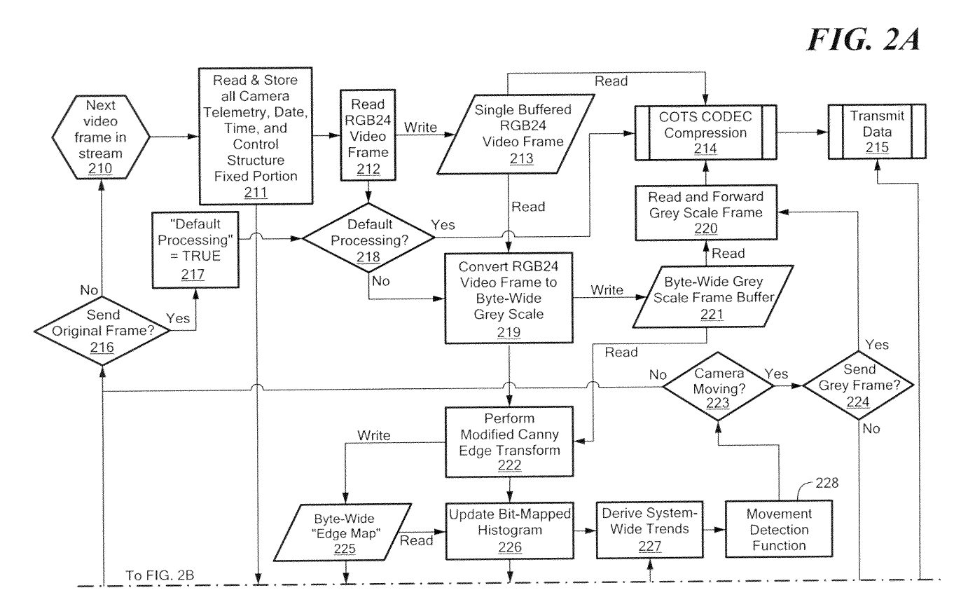

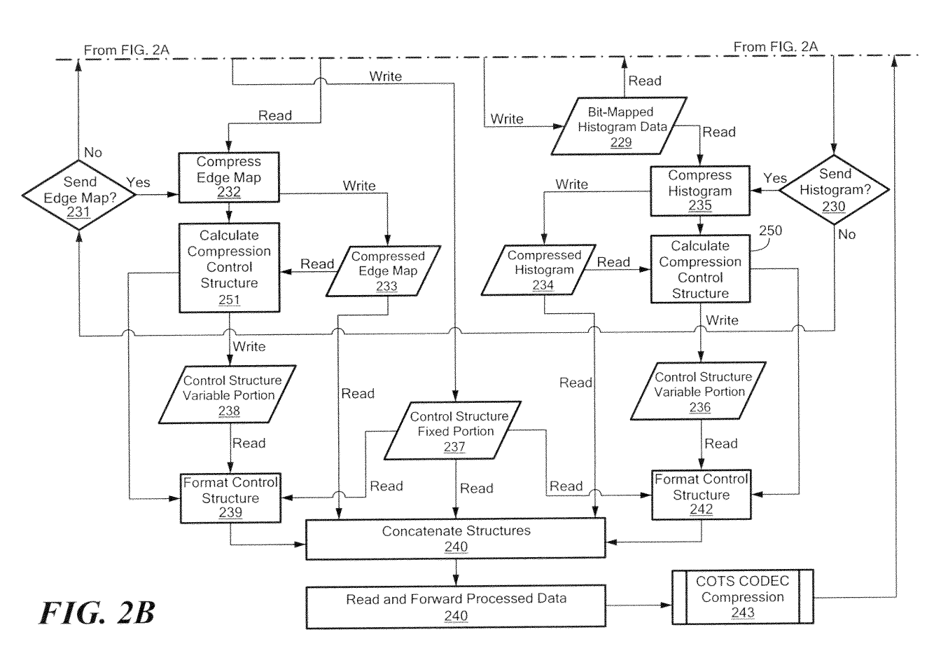

FIG. 2 shows exemplary processing steps for the system 100 of FIG. 1 to implement image processing and transmission in accordance with exemplary embodiments of the invention. In step 210, the next frame in a sequence of frames occurring in a video stream produced by a camera (or other imaging device) having a field of view is presented to a software interface. In step 211, information regarding the date, time, camera telemetry (pan angle, tilt angle, roll angle, elevation, etc.), and the “fixed portion” of a data structure known as the “Control_Block”, described in detail below, is retrieved and written to the “Control_Block_Fixed_Portion” 237.

The exemplary camera telemetry portion of the Control_Block is given below.

```
struct timespec_t
  {
    _time64_t ltime;
  };
struct position_t
  {
    double GPSfixLatitude;
    double GPSfixLongitude;
    double GPSfixAltitude;
    short GPSnoOfSatellites;
    short GPSmode;
  };
struct attitude_t
  {
    //
    // Camera Orientation
    //
  float pitch_angle;
  float roll_angle;
  float yaw_angle;
    //
    // Optics
    //
  float focalLen;
  float aperture;
    //
    // Canny Parameters
    //
  int effect;
    float Sigma;
    float tHigh;
    float tLow;
    //
    // Frame Size in pixels
    //
    unsigned int cols;
    unsigned int rows;
    };
struct motion_t
  {
  float geoCourse;
  float geoVelocityNorth;
  float geoVelocityEast;
  float horizontalVelocity;
  float horizontalAccceleration;
  float verticalVelocity;
  float verticalAcceleration;
  float rollRate;
  float pitchRate;
  float headingRate;
  float zoomRate;
  float agcRate;
    };
struct vector_t
  {
  attitude_t attitude;
  motion_t motion;
  };
struct ownship_t
  {
  unsigned char camera_found;
  unsigned char gps_found;
  unsigned char ins_found;
  timespec_t timeStamp;
  vector_t vector;
  position_t position;
  };
```

Hence, the C++ structure called “ownship_t” contains sufficient storage for a broad range of measures sufficient for expressing the geospatial position of the imaging device, the angle of view, direction of view, pan, tilt, and any other information one might imagine in a typical embodiment of this invention.

In step 212, the RGB24-compliant video frame is read by the computer's native operating system from the video buffer native to the camera, or its software interface, and written to an accessible buffer 213. In step 218, a test of a user-selectable software option to process or bypass “default processing” occurs. If default processing is TRUE (e.g. selected), then in step 214 the address of the buffer 213 is passed to the default COTS CODEC where the information is compressed by the COTS CODEC, and forwarded for transmission in step 215 as handled by default by the computer's operating system. If “default processing” in step 218 is FALSE (e.g. deselected), then the process proceeds to step 219. In step 219, the RGB24-compliant video frame is read in buffer 213 and applies a grey-scale conversion algorithm, described below, which converts the 3 bytes describing each pixel into a 1-byte value per pixel, and writes that value to the corresponding pixel location in the “Byte-Wide Grey Scale Frame Buffer” 221. At this point, the total size of the frame has been reduced from 3 bytes per pixel to 1 byte per pixel, and the colorization of the video frame is known in the art as a “grey scale” rendition of the image.

In step 222, the process performs a modified Canny Transform on the grey scale image in buffer 221 where it is read and converted into an “edge map” which is then stored in the Byte-Wide Edge Map buffer 225. During step 222, each pixel that is determined to represent an “edge” in the image is set to the binary value of 0, and any pixel that is determined to represent something other than an edge in the image is set to the value 255. Hence, only two possible binary values are possible for any given pixel in the image (0, or 1; “EDGE”, or “NOEDGE”).

In step 226, the process performs the Update Bit-Mapped Histogram function in which buffer 225 is read and used to update the bit-mapped histogram data structure, which is subsequently written to buffer 229, the Bit-Mapped Histogram Data. In step 227, the process derives System-Wide Trends in which buffer 229 is read, and a number of system wide statistics are calculated and stored in process memory. In step 228, in a movement detection function, the statistics calculated in step 227 are evaluated, and a test is performed in step 223 to determine whether the camera is moving. If it is determined that the camera is not in motion, processing continues with step 216, which tests a user-selectable parameter to send the original RGB24 video frame in the absence of camera motion. If the result of the test in 216 is true, then processing continues with step 217, Default Processing=TRUE, which sets an internal flag to true. Processing then continues with step 218, as described above.

If the result of the test in step 216 is FALSE, then processing for the existing frame stops, and control is returned to the beginning step 210. If the result of the test in step 223 was TRUE (e.g., the camera is thought to be moving), then processing continues with the test in step 224, Send Grey Frame. In step 224, the process tests a user-selectable option to transmit the grey scale frame if the camera is thought be in motion. If the result of this test 224 is TRUE, then processing continues with step 220, Read and Forward Grey Scale Frame. In step 220, the buffer 221 is read and passed to step 214, and then on to step 215 for transmission. If the result of the test in step 224 is FALSE, then processing continues to step 230, Send Histogram, to determine the state of a user-selectable option to transmit the entire histogram. If the result of the test in step 230 is TRUE, then processing continues with step 235, Compress Histogram, in which the buffer 229 is read and compressed using an inventive compression technique and stored in buffer 234, the Compressed Histogram.

Processing then continues in step 250, Calculate Compression Control Block, in which details about the variable length compressed data in buffer 234 are calculated and stored in buffer 236, Control Block Variable Portion. Processing then continues to step 242, Format Control Block, where the fixed portion 237 is read and combined with the variable portion of the Control Block 236 in local memory storage such that the combined buffer has a single starting address in buffer 237 with a length that subsumes both the fixed portion (buffer 237) and the variable portion (buffer 236).

Processing then continues with step 240, Concatenate Structures, where the compressed histogram is concatenated to the end of buffer 237 and the length of buffer 237 is updated to reflect the appended data. Processing then continues to step 241, Read and Forward Processed Data, which receives the address of buffer 237 from step 240 and passes that address to step 243, COTS CODEC Compression. Note that step 243 and step 214 may be identical, or substantially similar, in function and intent, and depicted in the diagram twice in order to avoid complicating the diagram.

Processing continues with step 215, as described above. If the result of the test in step 230 was FALSE, then processing continues with step 231, Send Edge Map. If the result of the test in step 231 is TRUE, then processing continues with step 232, Compress Edge Map. In step 232, the contents of buffer 225 are read and compressed using an inventive compression algorithm. The compressed data is then written in step 232 to buffer 233 Compressed Edge Map.

Processing then continues with step 251, Calculate Compression Control Block where details about the variable length compressed data in buffer 233 are calculated and stored in buffer 238 Control Block Variable Portion. Processing then continues to step 239 Format Control Block where the fixed portion 237 is read and combined with the variable portion of the Control Block 238 in local memory storage such that the combined buffer has a single starting address in buffer 237 with a length that subsumes both the fixed portion (buffer 237) and the variable portion (buffer 238). Processing then continues with step 240, Concatenate Structures, where the compressed edge map is concatenated to the end of buffer 237 and the length of buffer 237 is updated to reflect the additional data. Processing then continues to step 241, Read and Forward Processed Data, which receives the address of buffer 237 from step 240 and passes that address to step 243, COTS CODEC Compression. Note that step 243 and step 214 may be identical in function and intent, and depicted in the diagram twice in order to avoid complicating the diagram. If the result of the test in step 231 is FALSE, then processing continues with step 216, as described above.

As is known in the art, each composite video frame is composed of relatively small ‘dots’ called “pixels”. Each pixel has a unique position in the frame described by its x-coordinate and its y-coordinate. The resolution of a video frame is expressed as the count of pixels horizontally along the x-axis, and the count of pixels vertically along the y-axis. For instance, a frame with a resolution of 1024×768 describes a frame with 1,024 columns of pixels along the x-axis (width) and 768 rows of pixels along the y-axis (height). The total number of pixels in the frame is the product of these two values. Hence, a hypothetical frame having a resolution of 1024×768 is composed of a total of (1024×768)=786,432 pixels.

As is also known in the art, every pixel has a set of properties that describe it. For instance, each pixel has a unique position in a frame given by its Cartesian coordinates. Each pixel also portrays or renders a particular color. In digital computing, the color portrayed by a particular pixel is determined by the numeric value of the pixel. For instance, in a frame known as a “grey scale” frame, each pixel is capable of rendering either black, white, or a shade of grey between black and white. The number of discrete shades between black and white (inclusive) is a function of the length of the binary value associated with the pixel. For instance, if a single bit is used to describe the possible colors of a given pixel, then only two colors are possible since a single bit can contain at most two possible values (‘1’ and ‘0’). If two bits are used to describe the possible colors of a given pixel, then only four possible colors are possible since two bits can represent at most four possible values (‘00’, ‘01’, ‘10’, and ‘11’). The number of possible values is equal to 2ⁿ, where n is equal to the number of bits used to express the value of the pixel. For the purposes of describing, but not limiting, exemplary embodiments of the invention, it is assumed that every pixel is described by at least 1 byte (8 bits), and therefore there are at most 2⁸=256 shades of grey possible for each bit position.

Taken together, the pixels are used to populate a frame in a two-dimensional plane, and the binary values of each pixel establish their individual shades of grey. When fully assembled and rendered the result is a “grey scale” frame. In this case, the frame is comprised of a single plane of pixels that is sufficient for rendering a grey scale picture. Given our hypothetical resolution of 1024×768, exactly 786,432 pixels are required to render the grey scale frame. Because each pixel requires 1 byte of storage to describe its shade of grey, then 786,432 bytes of storage are required to contain our hypothetical frame.

As is further known in the art that in order to create the perception of color, it is necessary to create more than one plane of pixels. In an exemplary embodiment, one assumes an incoming color frame that is RGB24 compliant, then it is useful to describe a color frame as a frame consisting of exactly 3 planes of pixels. Each plane is uniquely assigned to represent either the shades of red (the “R” plane), shades of green (the “G” plane), or shades of blue (the “B” plane) (hence, “RGB”). Each pixel in each plane is described by a single byte and therefore is capable of rendering up to 256 shades of red, green, or blue, depending upon which plane it occupies. A given color pixel in the RGB24 format, therefore, is described in total by three bytes of information (3 bytes*8 bits per byte=24 bits, hence the “24” in RGB24). In this way it's possible for a single pixel to render up to 224=16,777,216 distinct colors, which are unique combinations of red, green and blue. The amount of information to describe an RGB plane is thus three times more than the amount of information required to describe a grey scale frame. For each pixel, there are now 24 bits of information whereas each pixel in the grey scale frame required only 8 bits. The net storage required to represent an RGB24 frame having a resolution of 1024×768 is now 1024×768×3 (bytes per pixels)=2,359,296 bytes.

As described above, exemplary embodiments assume the availability of color frames that are RGB24 compliant. That is to say, color frames composed of three planes (RGB), and each pixel in each plane described by 8 bits for a total of 24 bits per pixel position (RGB24).

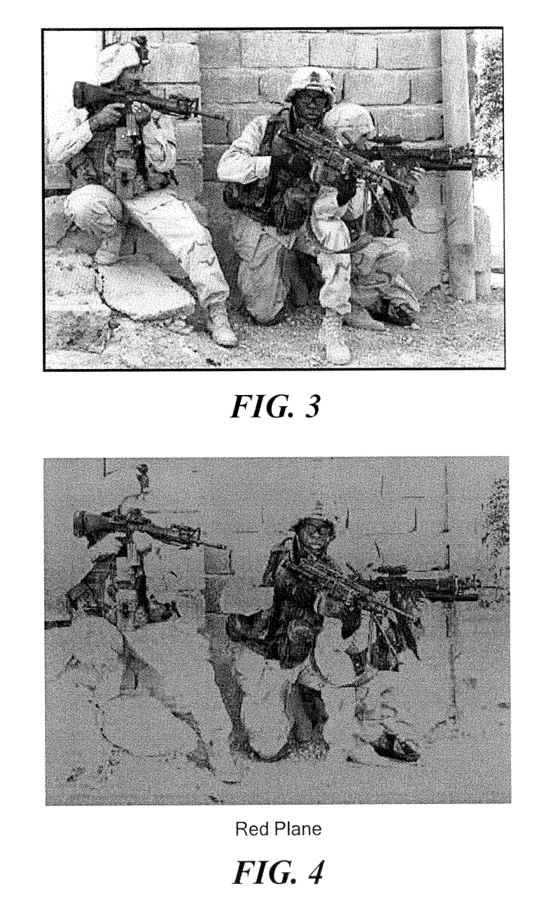

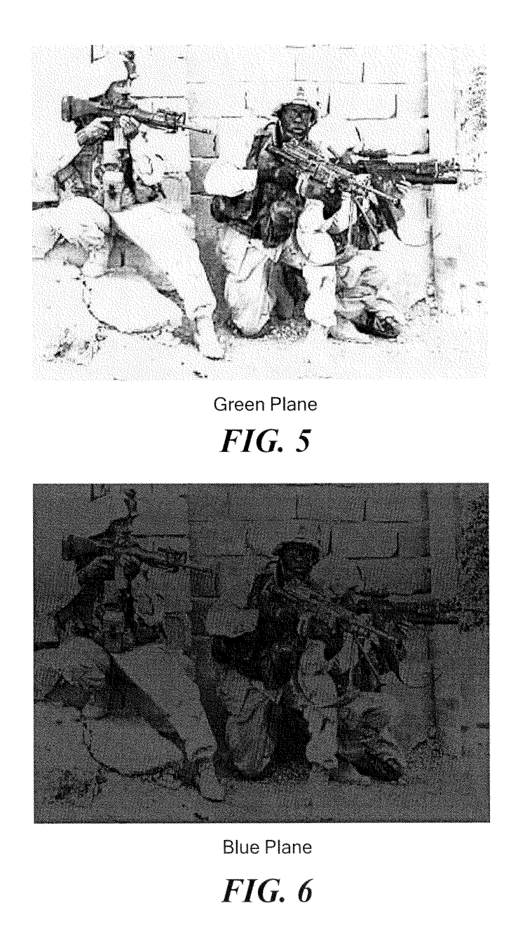

Returning to step 213 of FIG. 2, FIG. 3 represents a typical color frame existing in the buffer mentioned above. This frame is one in a sequence of frames that together form a video sequence and is RGB24 compliant. The sample frame in FIG. 3 is composed of three planes (Red, Green, Blue) shown in FIG. 4, FIG. 5, and FIG. 6, respectively. Each plane can be separately accessed in memory, and if rendered, would appear as shown in FIG. 4 (Red), FIG. 5 (Green), and FIG. 6 (Blue). When the planes in FIGS. 4, 5 and 6 are overlaid, the frame in FIG. 3 results.

In step 219 as discussed above, a frame, such as the one in FIG. 3, is read and converted into a grey scale frame. This conversion is made according to the following:
Let f={(r(x,y), g(x,y), b(x,y), z(x,y))|r is a pixel in the red plane having Cartesian coordinates (x,y), g is a pixel in the green plane having Cartesian coordinates (x,y), b is a pixel in the blue plane having Cartesian coordinates (x,y), and z is a pixel in the resultant grey-scale plane having Cartesian coordinates (x,y), for any value of x and y describing the position of each pixel}
Let p=a pixel with coordinates (x,y).

∀pεf,z=(r*i)+(g*j)+(b*k)∩(2⁸−1)
where i, j and k are selectable values in the range of 0 to 255, the range of z is 0 to 255, and r, g, b, and z are the binary values of the red, green, blue and grey-scale pixels, respectively, each having ranges of 0 to 255.

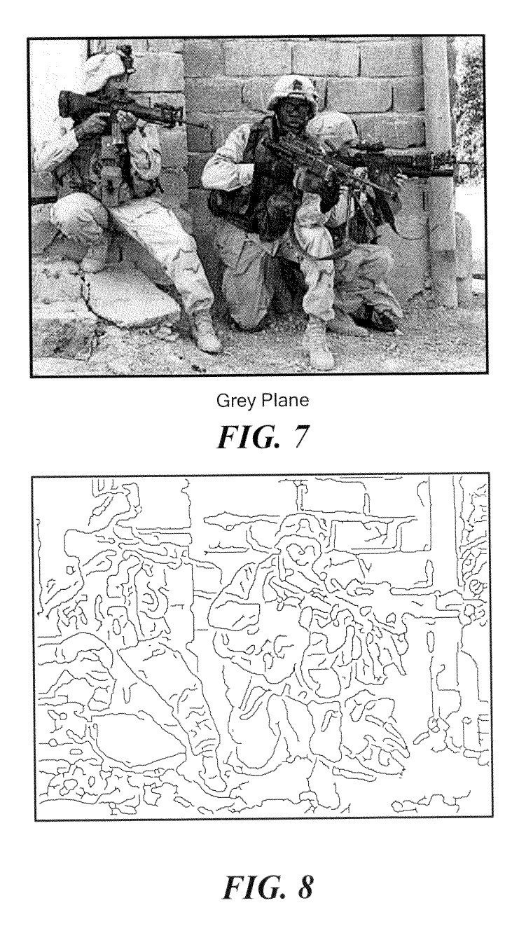

FIG. 7 illustrates the results of the above conversion. This video frame is now a single plane, and each pixel represents one of 256 possible shades of grey described by a single byte (8 bits). As a direct result of the conversion of the RGB24 frame in FIG. 3 to a Grey Scale frame in FIG. 7 as performed by step 219 above, the total amount of information required to represent the frame is reduced by two thirds, since three planes of information (RGB) have been reduced to one plane of information (Grey Scale). In the case where an RGB24 video frame having a resolution of 1024×768 appears at the input buffer in step 213 with a total size of 2,359,296 bytes, the conversion step 219 writes a grey-scale frame of resolution 1024×768 into buffer 221 having a total size of 786,432 bytes. This compression step shown as step 219 above is a lossy compression step as defined above. The information that has been lost is the information required to restore the frame in buffer 221 to its original RGB24 rendition as it existed in buffer 213.

In step 222, the image in buffer 221, depicted hypothetically in FIG. 7, is read and converted in an exemplary embodiment into a rendition known in the art as an “Edge Map” using a modified Canny Edge Transform algorithm. In general, where the Canny Edge Transform determines that a particular pixel represents an edge in the image, the value of the pixel is set in binary to the decimal equivalent 0 (“EDGE”). Where the Canny Edge Transform determines that a particular pixel in the grey scale image does not correspond to an edge, the algorithm sets the value of the pixel is set in binary to the decimal equivalent 255 (“NOEDGE”). FIG. 8 is an example of the resulting image stored in buffer 225. The image in buffer 225 contains pixels that have 1 of 2 possible values (0 or 255) as portrayed in the exemplary rendering of FIG. 8.

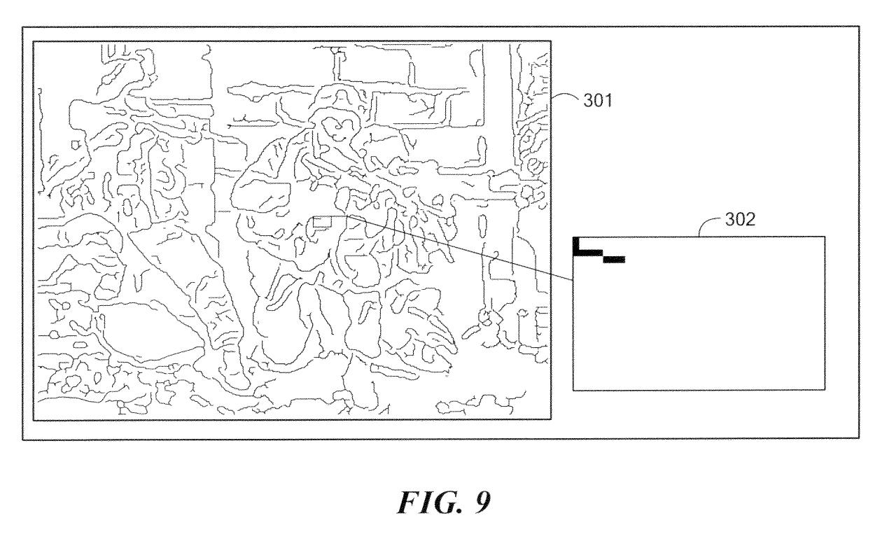

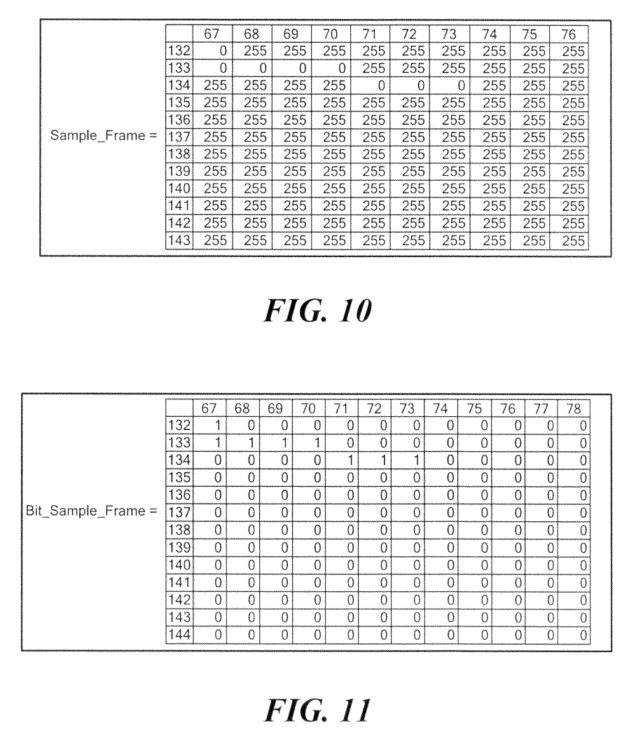

FIG. 9 depicts FIG. 8 with a small section of the frame 301 highlighted by enclosing a section of the frame with a box 302 that magnifies the corresponding section in 301. As such, the image is stored as a vector of bytes and is referred to hereafter as the Byte_Frame₍ₐ₎. The number of elements in Byte_Frame vector is equal to FPixels as defined below, and the value of a refers to the a^{th} byte in the array and has the range 0 through FPixels−1.

The exemplary magnified section 302 is represented in the edge map as pixel columns 67 through 76 and pixel rows 132 through 143 as shown in FIG. 10 below. Each edge map frame is a matrix of binary values 0 or 255 stored in binary form using 1 byte of storage per pixel in the vector Byte_Frame. The decimal value 0 represents black (“EDGE”) and the decimal value 255 represents white (“NOEDGE”). In FIG. 10 we show a portion of the numerical values for the most recent frame in the sample. The table illustrates the decimal values in pixel columns (x-axis) 67 through 76, and pixel rows (y-axis) 132 through 143. Each pixel position is a value at some (x,y) coordinate. For instance, the value at (67,132) is 0, and the value at (76,143) is 255.

This compression step shown as step 222 in FIG. 2 is a lossy compression step as defined above. Note that each pixel position is allocated 1 byte of storage and that each byte of storage contains 1 of at most 2 possible decimal values (0 or 255). In the example in FIG. 10, the total number of bytes required to store the 10 pixels in pixel row 132 is 10 bytes. This is far more storage than is required to store 1 of 2 possible states.

The information that has been lost in the transform from the grey scale frame in buffer 225 to the edge map frame stored in buffer 221 through process 222 is the information required to restore the Edge Map frame in buffer 225 (FIG. 8) to its grey scale rendition as it existed in buffer 221 (FIG. 7). Hence this step is a lossy compression step, and there is no immediate benefit to this loss since there is no net reduction in the amount of information required to store this Edge Map as it exists in the buffer 225. However, the Edge Map frame 225 has properties which allow the total number of bytes required to store the information to be further reduced by seven eighths without further loss of information. Specifically, as there are no values other than 0 or 255 in the Edge Map, the same data can be represented by ones or zeros. This property allows the image to be bit-mapped since bits also have 1 of 2 possible values (0 or 1).

Step 226 reads the image in buffer 225 and creates a bit-mapped version of the Edge Map in local storage. The storage for the bit-mapped version of the frame can be treated as a vector of bits having FPixels bits, but on most byte-addressable computational platforms it is physically accessed as a byte-addressable vector of CEILING(FPixels/8) bytes, where CEILING is a well known function that rounds any quotient with a non-zero fraction to the next highest integer. We call this bit-mapped vector the Bit_Frame₍ₐ₎, where a is the index into the byte-addressable vector. The notation pixel_{(x,y,z)}, as defined below, is used to represent the address of a particular bit. This lossless compression occurs using a temporary buffer in step 226. Converting the above frame to zero and one values will yield the following result.

In this representation of the bit-mapped Edge Map each cell at some (x,y) coordinate is a bit position within a byte, as opposed to an entire byte. Since there are 8 bits in a byte, then the amount of memory required to express the first 8 pixels (x=67 through 74) in pixel row 132 (y=132) is 1 byte. When a bit is “set”, we say it is a 1 and define that state as the representation for a black pixel, called an Edge pixel hereafter. When a bit is “clear” we say it is a 0, and define that state as the representation of a white pixel, called a NoEdge pixel hereafter.

The size of the bit-mapped Edge Map frame in the buffer 226 is 0.125 times the size of the Edge Map frame in buffer 225. In our example, the amount of memory required to store the bit-mapped image is now 0.125×786,432 bytes=98,304 bytes.

Given our example, the total amount of storage required by the image has dropped from 2,359,296 bytes to 98,304 bytes (a 95.8% reduction), with no further compression. The cost of this compression, however, has been the loss of color, grey scale, texture and other detail in the frame. Yet, the frame still contains enough information such that a viewer of the frame can determine meaningful information. More importantly, the frame contains sufficient information to detect trends that indicate a camera in motion, and other properties such as isolated objects within the frame that are or are not in motion relative to other objects in the frame, and respond by altering the information being transmitted.

As is known in the art and defined above, video is a technique for creating the illusion of motion by rapidly displaying a time-ordered sequence of still photographs, or frames. Over a period of precisely 1 second, for example, it is possible to sequence through as few as 0 and as many as hundreds or thousands of frames. The number of frames displayed in rapid succession over 1 second is called the “frame rate” of the video stream. The unit of measurement is usually “frames per second”, or “fps”. Typical frame rates for COTS video cameras are between 15 and 30 fps.

In order to perform any video analysis in the time domain, it's necessary to examine multiple frames over some closed interval. Determining motion and relative motion require the analysis of multiple frames collected over some interval. In an exemplary embodiment, a system includes a mechanism for storing multiple frames over some closed interval. Any given frame can be analyzed on its own, or in the context of frames that succeed or precede it within that closed interval. The mechanism for storing those frames includes a mechanism for also storing the data that results from the analysis of each frame, each frame in the context of the other frames within the interval, and metrics derived from an analysis of all frames in the sample. The inventive mechanism for storing and analyzing data is referred to as a “Bit Histogram.” The Bit Histogram includes a data structure and can include software processes that operate upon the Bit Histogram.

In one embodiment, the Bit Histogram is a component of a class, in the manner of object oriented programming, called a BitHisto. The BitHisto contains the Bit Histogram data structure and inventive processes to operate on the Bit Histogram. The BitHisto can be provided as a “class” in a manner typical of object oriented programming using languages such as C++ or Java, or as a data structure and independent set of processes using a programming paradigm typical of the C, Fortran, Assembler languages, or any other manner of producing binary representations of data and instructions on any manner of computational hardware. In the illustrative embodiment, the BitHisto is treated as a class and instantiated as an object, in a manner befitting object oriented programming, using the C++ programming language.

A time-ordered sequence of frames can be arranged one behind the other, with the most recent frame at the front of the stack, and the oldest frame at the back of the stack. Each frame exists two-dimensionally, with the width of the frame forming the x-axis, and the height of the frame representing the y-axis in the Cartesian plane. When appearing in a stack, the depth of the stack occurs along the z-axis. The units of measure along the x-axis represent the pixel column number in the frame, the units of measure along the y-axis represent the pixel row number in the frame, and the units of measure along the z-axis represent the frame number. For this reason, the term Cols is defined as the total number of pixel columns in a frame, and the algebraic term x is defined to refer to a specific column, and position along the x-axis, in the frame. The term Rows is defined as the total number of pixel rows in a frame, and the algebraic term y is defined to refer to a specific pixel row, and position along the y-axis in the frame. The term Fpixels is defined as follows:

Fpixels=Cols×Rows

As described above, given a video apparatus having a resolution of 1024×768, we take the integer value 1024 to mean the total count of pixel columns oriented along the x-axis, and the integer value 768 to mean the total count of pixel rows oriented along the y-axis. We say therefore that Cols is 1024 and the range of x is 0 to 1023. We further say that Rows is 768 and the range of y is 0 to 767. We further say that

Fpixels=Cols×Rows=1,024×768=786,432

The term Sample is defined as the quantity and collection of frames gathered for analysis and the algebraic term z is defined to refer to a specific frame, and position along the z-axis in the Sample. Given an exemplary Sample of 8 frames oriented as described above and located along the z-axis in positions 0 through 7, the frame at z=0 is the most recent frame and the frame at z=7 is the oldest frame in an exemplary sample of 8 frames. We say, therefore, that Sample is 8, and the range of z is 0 to 7.

We further define the term pvmPixels as the total number of individual pixels in a Bit Histogram, calculated as follows:

pvmPixels=Sample×Cols×Rows

Given a Sample of 8 frames having Cols=1,024 and Rows=768, the value of pgmPixel would thus be

pvmPixels=8×1,024×768=6,291,456

When a new frame is ready to add to the Sample, the frame at z=7 is overwritten with the contents of the frame at z=6, the frame at z=6 is overwritten with the contents of the frame at z=5, and so on. This eventually results in the frame at position z=0 being a copy of the frame at z=1. The incoming frame is therefore written to the frame at position z=0. This arrangement is known in the art as a First In-First Out (FIFO) buffer and is a common embodiment in the art.

A desirable property of a FIFO arrangement of frames is that the value of x and y is the same for any pixel with coordinate (x,y) in any of the frames along the z-axis. For instance, the (x,y) coordinates for the first pixel in the frame at z=0 is the same as the (x,y) coordinate for the first pixel in the plane where z=1, z=2, and so on. It is thus possible to create a vector of a length equal to Sample for each unique position described by the coordinates (x,y). A frame containing a total of 4 pixels, for example, would require 4 such vectors. If 8 frames were collected, each of the 4 vectors would be vectors of 8 elements. In fact, the number of vectors required to populate a Bit Histogram is equal to Fpixels as defined above. We call each vector a “Pixel_Vector” as it describes a time-ordered history of a particular pixel position known by its (x,y) coordinates.

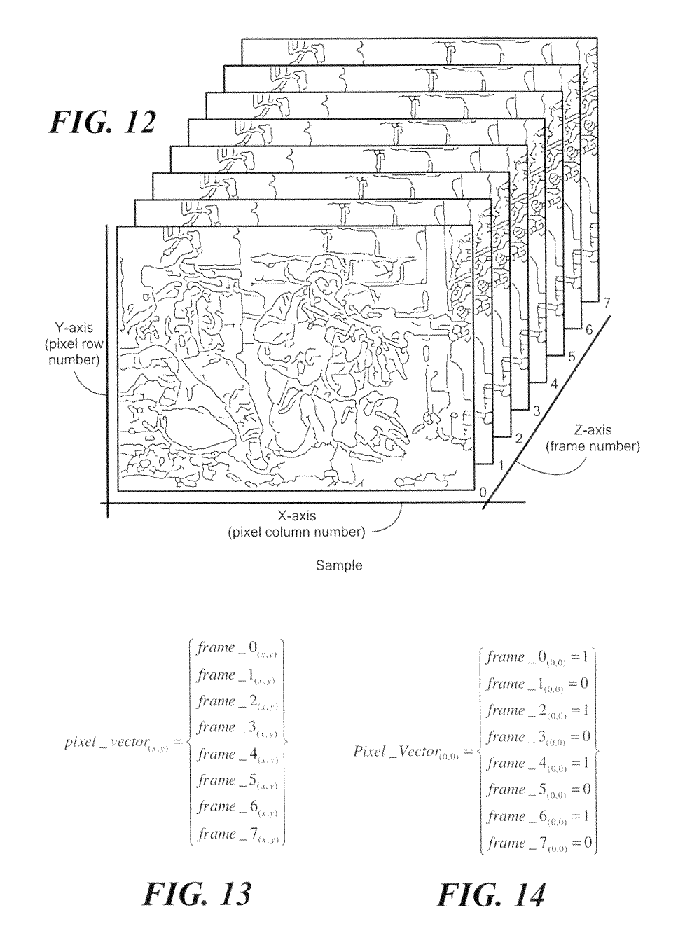

FIG. 12 shows an exemplary sequence of bit-mapped Edge Maps having arbitrary frame numbers 0-7, as they would appear in the Bit Histogram data structure if they could be rendered directly. Any given Pixel_Vector is expressed as follows: Pixel_Vector_{(x,y)}, where x is the pixel column number and y is the pixel row number as defined above. The number of elements in any given Pixel_Vector is equal to Sample as defined above. The value of each element is either Edge or NoEdge as defined above. Hence, a Pixel_Vector containing a sample of 8 frames can be described as shown in FIG. 13.

The pixel information in the Bit Histogram structure can be seen as a matrix of Pixel_Vectors and as such is hereafter called the Pixel_Vector_Matrix. A particular pixel anywhere in the Pixel_Vector_Matrix is known as pixel_{(x,y,z)}. A particular Pixel_Vector can also be selected using the notation pV₍ₛ₎ where s=the ordinal occurrence of a Pixel_Vector_{(x,y)} found by the formula, s=y(Cols)+x

A particular pixel in a particular frame z within the Pixel_Vector_Matrix can therefore be referenced as pixel_{(s,z)}. Regardless of the resolution of a video frame, or the number of frames in Sample, the term “Pixel_Vector_Matrix” is defined herein as a matrix containing Fpixels Pixel_Vectors.

Now consider the exemplary Pixel_Vector_{(0,0)} in a sample of 8 frames as shown in FIG. 14. Suppose that for all even values of z, pixel_{(0,0,z)} is set to Edge, and for all odd values of z, pixel_{(0,0,z)} is set to NoEdge. The following Pixel_Vector_{(0,0)} would result. The contents of the Pixel_Vector are data. Certain properties of the data contained by each Pixel_Vector is called Pixel_Vector Meta Data. For instance, in the exemplary Pixel_Vector in FIG. 14, there are 4 occurrences of Edge, and 4 occurrence of NoEdge. Starting with frame_0_{(0,0)}, the value in the vector changes from one value to another 7 times. There are no “sprees”.

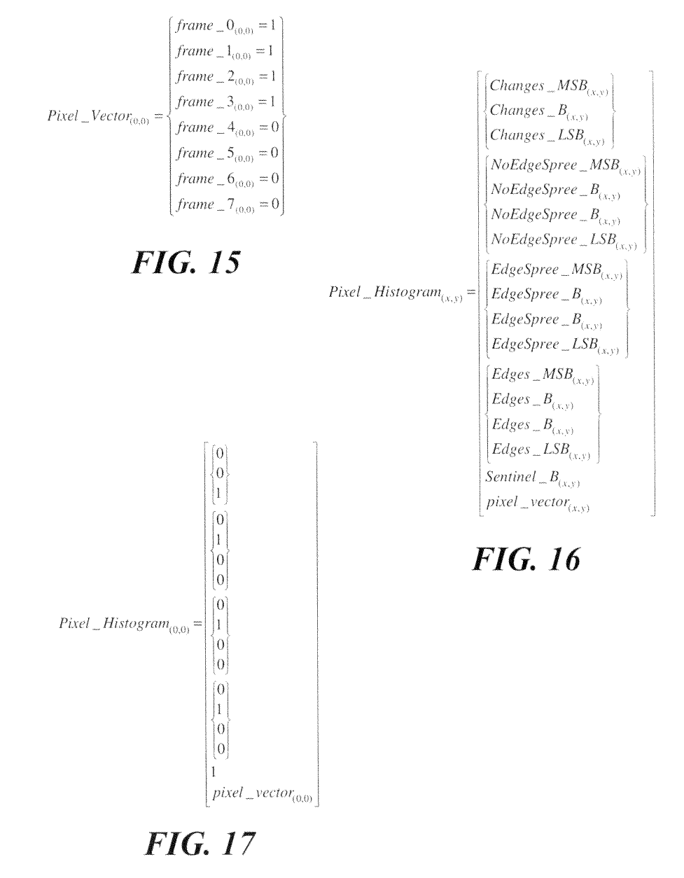

A spree is defined herein as any occurrence of consecutive values, regardless of whether the value is a series of Edge or NoEdge pixels. Consider the exemplary Pixel_Vector in FIG. 15 illustrating the case where there are 2 sprees, each of length 4. There are four consecutive occurrences of Edge pixels in frame_0 through frame_3, and four consecutive occurrences of NoEdge pixels in frame_4 through frame_7. The term Edge_Spree is defined as the largest number of consecutive Edge pixels in a Pixel_Vector. The term NoEdge_Spree is defined as the largest number of consecutive NoEdge pixels in a Pixel_Vector. In the exemplary Pixel_Vector in FIG. 15, the value of Edge_Spree is 4, and the value of NoEdge_Spree is 4.

In an exemplary embodiment, the Bit Histogram includes the Pixel_Vector_Matrix and other data structures designed to store additional quantities associated with each Pixel_Vector. The quantities are “Edges”, “Changes”, “Edge_Spree” and “NoEdge_Spree.”

Edges is defined as the total count of Edge Pixels in the Pixel_Vector, and is stored in a register called the Edges_Register as defined in detail below. Changes is defined as the total count of changes from Edge to NoEdge, or NoEdge to Edge, in the Pixel_Vector, and is stored in a register called the Changes_Register as defined in detail below. Edge_Spree is defined as the largest count of pixels comprising a consecutive series of Edge pixels in a Pixel_Vector and is stored in a register called the Edge_Spree_Register as defined in detail below. NoEdge_Spree is defined as the largest count of pixels comprising a consecutive series of NoEdge pixels in a Pixel_Vector, and is stored in a register called the NoEdge_Spree_Register as defined in detail below. The length of each of these four registers is directly related to the length of the Pixel_Vector.

The Edges_Register should be able to store the highest possible count of Edge pixels in a Pixel_Vector. The highest possible count of Edge pixels in a Pixel_Vector is the length of the Pixel_Vector itself. In our exemplary Pixel_Vector in FIG. 15, there are at most 8 pixels, and therefore there can be at most eight Edge pixels appearing in the Pixel_Vector. In order to store the decimal value 8 in binary, the Edge_Register must comprise at least 4 bits which accommodate the decimal range 0 to 8.

The Edge_Spree_Register and No_Edge_Spree_Register are similarly constrained. At most, a spree of eight Edge pixels, or a spree of eight NoEdge pixels can occur in the exemplary Pixel_Vector shown in FIG. 12. Hence, the Edge_Spree_Register must contain at least 4 bits in order to store the largest possible spree of Edge pixels in a Pixel_Vector, and the NoEdge_Spree_Register must contain at least 4 bits in order to store the largest possible spree of NoEdge pixels in a Pixel_Vector.

The highest possible number of changes in a Pixel_Vector is always 1 less than the length of the Pixel_Vector. The Changes_Register therefore must contain at least 3 bits in order to represent 0 to 7 possible state changes (NoEdge to Edge, or Edge to NoEdge) occurring in the Pixel_Vector.

In order to accommodate the Edge_Register, Edge_Spree_Register, NoEdge_Spree_Register, and the Changes_Register, the length of each Pixel_Vector is extended by the total number of bits required to represent the quantities in each of the aforementioned registers. In addition, a single bit position, defined herein as a Sentinel, is used to mark the beginning of the Pixel_Vector Meta Data section. Taken together, the four registers and the Sentinel comprise the Pixel_Vector Meta Data. The entire resulting structure is defined herein as a Pixel_Histogram, as shown in FIG. 16.

An exemplary instance of the Pixel_Histogram_{(x,y)} shown in FIG. 16, which includes the exemplary Pixel_Vector_{(x,y)} in FIG. 15, is shown in FIG. 17.

The properties described above, can be summarized as follows.

1). The Pixel_Vector contains the most recent Sample of pixel values over time for a given pixel at Cartesian coordinates (x,y) in a frame.
2). The Pixel_Vector Meta Data contains 4 registers and a Sentinel.
3). The Changes_Register is a proper subset of the Pixel_Vector Meta Data, and contains the number of times a value in a Pixel_Vector alternates between an Edge and a NoEdge, or between a NoEdge and an Edge.
4). The length of the Changes_Register is always equal to or greater than the number of bits required to represent, in decimal, the length of the Pixel_Vector, minus 1.
5). The Edge_Spree_Register is a proper subset of the Pixel_Vector Meta Data, and contains the count of bits in the Pixel_Vector forming the largest sequence of consecutive Edge pixels in the Pixel_Vector.
6). The length of the Edge_Spree_Register is always equal to or greater than the number of bits required to represent, in decimal, the length of the Pixel_Vector.
7). The NoEdge_Spree_Register is a proper subset of the Pixel_Vector Meta Data, and contains the count of bits in the Pixel_Vector forming the largest sequence of consecutive NoEdge pixels in the Pixel_Vector.
8). The length of the NoEdge_Spree_Register is always equal to or greater than the number of bits required to represent, in decimal, the length of the Pixel_Vector.
9). The Edges_Register is a proper subset of the Pixel_Vector Meta Data, and contains the number of bits in the Pixel_Vector having the value Edge.
10). The length of the Edges_Register is always equal to or greater than the number of bits required to represent, in decimal, the length of the Pixel_Vector.
11). The Sentinel is a proper subset of the Pixel_Vector Meta Data, and always occupies the position between the Pixel_Vector and the Pixel_Vector Meta Data, and is always set to 1, and always has a length of 1 bit.
12). The Pixel_Vector Meta Data is a proper subset of the Pixel_Histogram.
13). The Pixel_Vector is a proper subset of the Pixel_Histogram.
14). The Bit Histogram is the matrix of Pixel_Histograms.
15). The Pixel_Vector_Matrix is the matrix of all Pixel_Vectors in the Bit Histogram.
16). Each Pixel_Histogram is treated as a binary string in this invention.
17). Each Bit Histogram is treated interchangeably as a vector or a matrix of Pixel_Histogram binary strings in this invention.

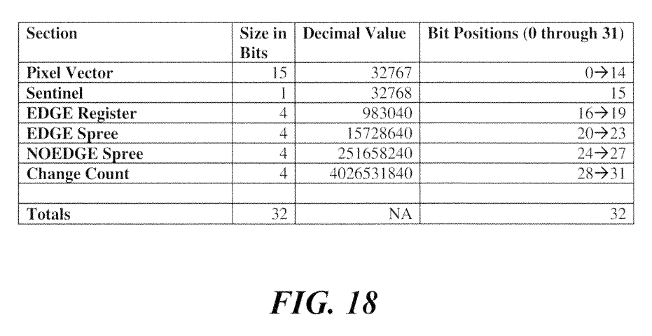

FIG. 18 shows an exemplary Pixel_Histogram definition in tabular form. The Pixel_Histogram contains an Edges_Register 402, an Edge_Spree_Register 404, a NoEdge_Spree_Register 406, a Changes_Register 408, a Sentinel 409, and a Pixel_Vector 410. In the illustrated embodiment the Pixel_Vector physically occupies bit position 0 through 14, having a length of 15 bits, and thus being capable of storing a Sample of 15 frames. The location of the Pixel_Vector in bit positions 0 through 14 is said to correspond to the Least Significant Word (“LSW”) of the Pixel_Histogram. Bit position 0 is said to be the Least Significant Bit (“LSB”) and contains the oldest of the samples. Bit position 14 is said to be the Most Significant Bit (“MSB”) and contains the most recent sample.

In the embodiment illustrated in FIG. 18, the Pixel_Vector Meta Data is composed of each of the four registers, each register being four bits in length and occupy the remaining 16 bits of the word following the Sentinel. It is said that the Pixel_Vector Meta Data occupies the Most Significant Word (“MSW”) of the Pixel_Histogram. If the video camera frame rate, as defined above, is sampling at fifteen frames per second, then the Pixel_Vector contains one second of compressed video, and the Pixel_Histogram contains one second of compressed video and Pixel_Vector Meta Data for each pixel position in the Sample.

An additional Register called the NoEdges_Register is created by subtracting the value of the Edges_Register from the length of the Pixel_Vector. This register is not accommodated in the Pixel_Vector Meta Data directly, but is derived for each Pixel_Histogram from the contents of its Pixel_Vector Meta Data.

In step 226 in FIG. 2, each bit-mapped Edge Map produced in the temporary buffer 226 is inserted into position z=0 of the Pixel_Vector_Matrix in FIFO fashion as described above.

In order to calculate the number of Edge pixels and store that count in the Edge_Register, an algorithm is performed, represented by the following pseudo code.

```
Begin
  Set Edge_Register = 0
  Set Copied_Pixel_Vector = Pixel_Vector
  Set Counter = Sample
  While Counter > 0
    If (Copied_Pixel_Vector & 1) Set Edge_Register = Edge
    Register + 1
    Copied_Pixel_Vector = Copied_Pixel_Vector/2
    Counter = Counter − 1
    Repeat While
Done
```

The number of changes from Edge to NoEdge or NoEdge to Edge are calculated in one embodiment of this invention using the algorithm represented by the following pseudo code.

```
Begin
  Set Changes_Register = 0
  Set Counter = Sample
  Set Copied_Pixel_Vector = Pixel_Vector
  While Counter > 1
    Set Temp = Copied_Pixel_Vector & 3
    If ((Temp != 1) && (Temp != 0)) Set Changes_Register =
Changes_Register + 1
    Copied_Pixel_Vector = Copied_Pixel_Vector / 2
    Counter = Counter − 1
    Repeat While
Done
```

The longest Edge spree and the longest NoEdge spree are calculated and stored in the Edge_Spree_Register and NoEdge_Spree_Register within the same algorithm, as represented by the following pseudo code.

### Set Longest_Edge_Spree=0

### Set Current_Edge_Spree=0

### Set Longest_NoEdge_Spree=0

### Set Current_NoEdge_Spree=0

For exemplary embodiments of the invention, it is assumed that a camera that is not in motion for an extended period of time results in bit histograms saturated with sprees. That is to say, a camera that is not in motion tends to exhibit the trait that Edge pixels in any given Pixel_Vector tend to persist as Edge pixels, and NoEdge pixels in any given Pixel_Vector tend to persist as NoEdge pixels, over the Sample. When the camera starts moving, the edges in the image in subsequent frames tend to sweep and move across the frame, which tends to disrupt the saturation of both types of spree. Yet in any Edge Map, there are normally far fewer Edge pixels than there are NoEdge pixels so that even if the camera is moving, the disruption to the NoEdge sprees tends to be significantly less dramatic than the disruption to the Edge sprees. The spree of interest in determining whether the camera is motionless, or whether the camera is in motion, is the Edge spree. Hence it is the disruption of the Edge sprees that is used in one embodiment in step 228 to determine whether the camera is still, or in motion. Hence, one embodiment of this invention in step 227 calculates the following quantities from the Pixel_Vector Meta Data in the Bit Histogram.

Let pBHEdge be that percentage of the Pixel_Vector_Matrix occupied by Edge pixels, calculated as follows:

$$TEp = {\sum }_{i = 0}^{S - 1} {Edge\_Register}_{( i )}$$

$$pBHEdge = TEp / pvmPixels$$

Let pBHESpree be that percentage of the Pixel_Vector_Matrix occupied by Edge pixels folming a part of Edge Sprees in the Pixel_Vector_Matrix, calculated as follows:

$$TESp = {\sum }_{i = 0}^{S - 1} Edge\_Spree {\_Register}_{( i )}$$

$$pBHESpree = TESp / pvmPixels$$

Let pBHChg be that percentage of the Pixel_Vector_Matrix that has undergone a change from an Edge pixel to a No Edge pixel, calculated as follows:

$$TCp = {\sum }_{i = 0}^{S - 1} {Changes\_Register}_{( i )}$$

$$pBHChg = TCp / pvmPixels$$

Let pMov be the difference between that percentage of the Pixel_Vector_Matrix containing Edge pixels, and that percentage of the Pixel_Vector_Matrix undergoing changes, calculated as follows:

pMOV=pBHEdge−pBHChg

Let pStill be the difference between that percentage of the Pixel_Vector_Matrix containing Edge pixels counted as Edge sprees, and that percentage of the Pixel_Vector_Matrix undergoing changes, calculated as follows:

pStill=pBHESpree−pBHChg

Let TxMode be a single bit which, when set to TRUE indicates that video being transmitted is the video signal native to the camera or other apparatus, and when set to FALSE indicates that the video being transmitted is the video signal produced by this invention. Let the value of TxMode be established by the following rule which is performed in step 228:

If pMOV<0 AND pStill <0, TxMode=FALSE

IfpMOV >0 AND pStill >0, TxMode=TRUE

As described above, the camera will switch from its native video mode shortly after it starts to move, and will switch back to its native mode shortly after it comes to rest. This provides a certain amount of hysteresis so that the camera does not rapidly switch back and forth between transmission modes in response to transients in one frame relative to others.

In step 223 (FIG. 2) the value of TxMode is evaluated and processing continues with step 216 if the value is TRUE, or with step 224 if the value is FALSE. In the case where processing continues with step 224, a selectable option to transmit the original color frame is tested and if set to TRUE, processing continues with step 217. Otherwise processing continues with step 210 where the next incoming video frame is accepted and processed.

In the case where the test performed in step 216 evaluates to TRUE, the system sets the value of a bit used to indicate “Default Processing” of the incoming video stream to TRUE. Processing then continues with step 218 which necessarily evaluates to TRUE as a result of the action taken in step 217. Processing then continues to step 214, where the native video format for the original frame is applied and transmitted in step 215.

In the case where the value of TxMode evaluates to TRUE in step 223, processing continues with step 224 where the value of a user or software selectable option called “Send Grey Frame” has been set. If the value of this flag is evaluated to TRUE, then processing continues with step 220 where the grey scale image is read from the buffer in 221 and processing then continues with step 214 where the grey scale frame is processed by a user or software selectable COTS CODEC and transmitted in step 215.

In the case where the value of the “Send Grey Frame” flag evaluates to FALSE in step 224, processing continues with step 230 where the value of a flag called “Send Histogram” is evaluated. If the “Send Histogram” flag evaluates to FALSE, then processing continues with step 231 where the flag called “Send Edge Map” is evaluated. In the case where the “Send Edge Map” flag evaluates to false, then processing continues with step 216 and then as described above. In the case where the “Send Edge Map” flag evaluates to TRUE in step 231, then processing continues with step 232.

In the case where processing flows from step 231 to 232, step 232 creates 2 additional data structures in order to compress the image at z=0 in the Pixel_Vector Matrix. The first data structure in 232 is called SWITCH, the second data structure created in 232 is called EMAP. The SWITCH structure is a variable length binary string, where every bit in the string corresponds to exactly 1 byte in EMAP. Hence, SWITCH₍ₐ₎ is equal to the a^{th} element of the vector of bits, having a length of exactly 1 bit. The data structure EMAP is a vector of bytes. Hence EMAP₍ₐ₎ refers to the aₕ byte in the EMAP vector. Each element in SWITCH corresponds to exactly 1 byte in the data structure EMAP. Hence SWITCH₍ₐ₎ is a flag that indicates one of two possible interpretations of the byte value corresponding to EMAP₍ₐ₎. If the value of SWITCH₍ₐ₎ is 0, then the value of EMAP₍ₐ₎ represents the count (up to 255) of consecutive bit-mapped NoEdge pixels. Since up to 8 consecutive bit-mapped NoEdge pixels can occur in a byte, and up to 255 bytes can be counted in a spree, then the maximum number of consecutive NoEdge pixels that can be represented by this one byte is 2040. A maximum compression ratio of 2040:1 is therefore possible.

If the value of SWITCH₍ₐ₎ is 1, then EMAP₍ₐ₎ represents the bit-mapped sequence of 8 pixels where at least 1 is an Edge pixel. The maximum compression ratio in this case is 8:1. The number of elements in the SWITCH vector is always equal to the number of elements in the EMAP vector but, because SWITCH is a vector of bits and EMAP is a vector of bytes, the total length of SWITCH measured in bytes is always no more than one eighth the length of EMAP. The specific length of both is a function of the information in the frame, but can never be greater than one eighth the value of FPixels.

When the compression method in step 232 is selected, the Byte_Frame in buffer 225, which persists in memory in one embodiment of this invention, is used in order to create a temporary data structure called “Bit_Edge” for computational speed. The information in Byte_Frame is identical to the information in the Pixel_Vector_Matrix at z=0, but is arranged in a manner that is more computationally efficient than using the image at Pixel_Vector_Matrix at z=0. Hence, the Byte_Frame 225 is read and then written to the Bit_Edge vector according to the following algorithm.

```
BEGIN
Set S = 0
While S < FPixels
  If Byte_Frame(s) > 0
    I = S / 8
    J = S % 8
    Bit_Edge[I] |= ( 128 >> J)
  End If
  S = S + 1
End While
DONE
```

The above creates a byte-addressable binary string that contains the proper position of each Edge and NoEdge pixel. Once this is accomplished, processing compresses the Bit_Edge vector by eliminating as many sprees of NoEdge pixels (bytes with values of 0) as possible.

The following, expressed in pseudo code, describes the process of reading the Bit_Edge vector, storing either a particular pixel or count of NoEdge pixels in EMAP, and setting the value of the corresponding bit in SWITCH to reflect the nature of the data in EMAP. The term “Bit_Edge₍ₛ₎” is defined to represent the computationally addressable byte containing 8 bits in the Bit_Edge vector. A Byte with a value of 0 is a byte that contains no Edge pixels and is therefore treated as a compressible byte. A byte with a value greater than 0 is a byte that contains at least 1, and at most 8 Edge Pixels, and is therefore treated as an uncompressible byte. In the following algorithm, SWITCH is treated as a bit-addressable vector, Bit_Edge is treated as a byte-addressable vector, and EMAP is treated as a byte-addressable vector.

```
BEGIN
Set S = 0
Set SWITCH_IDX = 0
Set EMAP_IDX = 0
Set EMAP_LENGTH = 1
While S < FPixels
  If Bit_Edge_{(S)} > 0
    EMAP_{(EMAP}_{_{—}}_{IDX)} = Bit_Edge_{(S)}
    SWITCH_{(SWITCH}_{_{—}}_{IDX)} = 1
    SWITCH_IDX = SWITCH_IDX + 1
    S = S + 1
  Else
    Set T = 0
    While T < 255 AND S < FPixels AND Bit_Edge_{(S)} EQ 0
      T = T + 1
      S = S + 1
    End While
    EMAP_{(EMAP}_{_{—}}_{IDX)} = T
    EMAP_IDX = EMAP_IDX + 1
  End If
  EMAP_LENGTH = EMAP_LENGTH + 1
End While
END
```

Once the above has completed its execution, the EMAP and SWITCH data structures are written to a buffer in step 233. Processing continues with step 251 where the length of EMAP and SWITCH are calculated and stored in a temporary data structure called a Control_Structure_Variable_Portion. This structure contains the length of the SWITCH vector and the length of the EMAP vector. Processing then continues with step 239 where the Control_Structure_Variable_Portion in 238 is read and combined with the Control_Structure_Fixed_Portion in buffer 237. The Control_Structure_Fixed_Portion has the following form in this embodiment.

struct Control_Structure_Fixed_Portion
{

| | | |
|---|---|---|
| ownship_t | navdata; | // A structure containing |
| | | // camera telemetry as shown |
| | | // below |
| int | Length_of_SWITCH; | // The total count of bytes in the |
| | | // SWITCH data structure |
| int | Length_of_EMAP; | // The total count of bytes in the |
| | | // EMAP data structure |
| int | TotalSize; | // The total size of the packet |
| int | nativeCODEC; | // A value indicating the |
| | | // the CODEC at Step 214 in |
| | | Fig 2 |
| }; | | |

Processing then continues with step 240 where the SWITCH and EMAP data structures are appended to the Control_Block_Fixed_Portion in order to arrive at a single data structure called a FRAME_PACKAGE. The FRAME_PACKAGE has the following form:

CONTROL_BLOCK_FIXED_PORTION
SWITCH
EMAP

Processing then continues with step 241 where the FRAME_PACKAGE is passed to a user or software selectable COTS CODEC for any final compression. Processing then continues with step 215 where the FRAME_PACKAGE is transmitted. Processing then returns to step 210 where the next frame awaits and processing proceeds as described above.

Corresponding to the Decompression Module 120 in FIG. 1 is the inventive CODEC that receives the compressed image, decompresses the received image, and forwards the decompressed image to the software application on client computer 108, also in FIG. 1, that has the task of decompressing the image. The received inventive compressed FRAME_PACKAGE has a variable total length. However, the variability in the length arises from the concatenation of the SWITCH and EMAP structures with the Control_Structure_Fixed_Portion. The Control_Structure_Fixed_Portion always appears at the beginning of the FRAME_PACKAGE, and is used by the decompression function to determine how the SWITCH and EMAP structures are configured, and their lengths, in bytes.

The first two values in the FRAME_PACKAGE are found in the “navdata” structure and correspond to the Cols and Rows of the frame. These are multiplied and stored in a local variable to hold the value of Fpixels. The quantity of bytes required to represent a frame is then calculation by dividing FpixelA by 8, since there are 8 bits in a byte. The starting address of the SWITCH data structure is offset from the first byte of the FRAME_PACKAGE by the fixed length of the Control_Structure_Fixed_Portion. The length of the SWITCH data structure is stored in the FRAME_PACKAGE. The starting address of the EMAP structure within the FRAME_PACKAGE is an offset from the beginning of the FRAME_PACKAGE equal to the sum of the lengths of the Control_Structure_Fixed_Portion, and the length of the SWITCH data structure as given by the variable Length_of_SWITCH within the Control_Structure_Fixed_Portion Structure. Hence, the boundaries and lengths of all data structures within the FRAME_PACKAGE may be derived.

The method for decompressing the compressed imagery encoded in the EMAP structure, therefore, is given by the following psuedo-code.

```
Set iPixel = 0
Set PixelBytes = Fpixels/8
Let EDGE_ARRAY = A Character Array of size PixelBytes
For Each Bit N in SWITCH
  If the value of Nth SWITCH bit = 1
    For Each Bit P in EMAP
      If the value of Pth EMAP bit = 1
        EDGE_ARRAY[Nth] = EDGE
      Else
        EDGE_ARRAY[Nth] = NOEDGE
      End If
  Else if the value of the Nth SWITCH bit = 0
    EDGE_ARRAY[Nth] = the value represented by the next 8 bits
    in EMAP
```

The result of the above psuedo-code is a complete decompression of the edge map. When rendered on the display of Client Computer 108 of FIG. 1, an edge map will appear, which is the most lossy result of the compression. Once the camera 102 in FIG. 1 stops moving, the image rendered in the display of Client Computer 108 will be a the original image received by this invention at 210 of FIG. 2.

In the case where the flag “Send Histogram” evaluates to TRUE in step 230, processing continues with step 235. In this process, the entire Pixel_Vector_Matrix is compressed and readied for transmission. The Pixel_Vector_Meta_Data is not included in this compression step. Instead, the Pixel_Vector_Meta_Data is re-calculated on the receiving end of the transmission where the compressed FRAME_PACKAGE is decompressed.

When viewed in 3 dimensions, the Pixel_Vector_Matrix is a cube of bits, some representing Edge pixels, and some representing NoEdge pixels. The depth of the Sample however is assumed to be significantly less than either the width (Cols) or height (Rows) of each frame. That is, Sample<Ros<Cols is assumed to hold for nominal applications. Each Pixel_Histogram includes a count of Edge pixels along the z-axis for a given value of (x,y). The compression algorithm in step 235 makes use of the SWITCH and EMAP structures in order to count the number of consecutive Pixel_Vectors (moving left to right, top to bottom) having SAMPLE NoEdge pixels. When a Pixel_Vector containing at least 1 Edge pixel is encountered, then the EMAP will contain the entire Pixel_Vector. Otherwise, the EMAP stricture will contain the count (up to 255) of consecutive Pixel_Vectors with SAMPLE NoEdge pixels. The SWITCH structure will indicate which bytes in the EMAP structure contain a count of consecutive Pixel_Vectors with SAMPLE NoEdge pixels, and which EMAP elements contain complete Pixel_Vectors having at least 1 Edge pixel. The EMAP structure will contain at least Fpixels/255 elements, and at most CEILING(SAMPLE/8)*FPixels elements. In oui example referenced above, a Sample of 15 frames having 1024 Cols and 768 Rows each results in an EMAP structure with between 3,085 and 1,572,864 bytes.

In one embodiment, the amount of ‘change magnitude’ required to transmit compressed data can be selected by the user. In another embodiment, the bit histogram processing provides feedback to the camera, or other device, to control camera positioning. The feedback can reduce the time and/or duration of camera movement so that periods of compressed data transmission are minimized.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A method, comprising:
receiving a stream of video frames from an image device;
generating edge maps for the video frames;
populating a data structure for containing the edge maps and for storing statistics for properties of the edge maps;
examining the statistics of the edge maps to determine whether movement of the image device is greater than a movement threshold;
selecting a format of the video frames to be transmitted based upon a time-series analysis of recent ones of the video frames, including compressing the video frames if the movement threshold is exceeded, and
transmitting the compressed video frames.

2. The method according to claim 1, wherein the movement threshold corresponds to an amount of change in edge pixels of the edge maps over time.

3. The method according to claim 2, wherein edge pixel information is contained in a pixel histogram.

4. The method according to claim 1, wherein the video frame is a color frame, and further including converting the color frame to a grey scale image.

5. The method according to claim 1, wherein the video frame is a grey scale image.

6. The method according to claim 1, further including maintaining a time-ordered arrangement of the edge maps in the data structure.

7. The method according to claim 1, further including calculating statistics describing properties for time-ordered pixels of the video frames in the data structure.

8. The method according to claim 1, wherein the statistics for the time-ordered pixels in the data structure are stored in the data structure.

9. The method according to claim 6, further including analyzing the time-ordered arrangement of edge maps to detect movement of the image device.

10. The method according to claim 1, further including determining a format of the data frame to be transmitted based on whether the movement threshold is exceeded.

11. The method according to claim 6, further including compressing the edge maps for transmission when the movement threshold is detected.

12. The method according to claim 11, further including decompressing the edge map for display.

13. The method according to claim 1, further including decompressing the compressed time-ordered series of frames for display.

14. The method according to claim 1, wherein the format of the video frame is selected from color, grey scale, edge map, and hostogram.

15. The method according to claim 1, further including updating a history of the edge maps with a current frame to replace a least current edge map in the history of edge maps, wherein the history of edge maps corresponds to a selected time interval.

16. The method according to claim 1, further including generating a bit histogram for storing the edge maps for the data frames for a selected time interval, storing an analysis of a first one of the edge maps, storing an analysis from a comparison of first one of the edge maps and other ones of the edge maps in the time interval, and/or storing metrics from an analysis of the edge maps in the time interval.
